(19) United States
(12) Patent Application Publication
(10) Pub. No.: US 2024/0072396 A1
(43) Pub. Date: Feb. 29, 2024

(54) BATTERY MODULE

(71) Applicant: SK On Co., Ltd., Seoul (KR)

(72) Inventors: Ho Yeon KIM, Daejeon (KR); Sang Tae AN, Daejeon (KR); Hwa Kyoo YOON, Daejeon (KR); Gang U LEE, Daejeon (KR)

(21) Appl. No.: 18/358,949

(22) Filed: Jul. 26, 2023

(30) Foreign Application Priority Data
Aug. 30, 2022 (KR) 10-2022-0109305

(51) Int. Cl. H01M 50/569; H01M 50/204; H01M 50/258; H01M 50/271; H01M 50/503; H01M 50/507

(52) U.S. Cl. CPC H01M 50/569; H01M 50/204; H01M 50/258; H01M 50/271; H01M 50/503; H01M 50/507

(57) ABSTRACT

A battery module is disclosed. In some implementations, the battery module includes: first and second sub-battery modules respectively including a cell stack including a plurality of battery cells and a sensing assembly sensing a state of the plurality of battery cells and an upper cover covering upper portions of the first and second sub-battery modules, wherein the upper cover includes a plurality of through-holes exposing portions of the first and second sub-battery modules, respectively.

### CROSS-REFERENCE TO RELATED APPLICATION(S)

This patent document claims the priority and benefits of Korean Patent Application No. 10-2022-0109305 filed on Aug. 30, 2022, the disclosure of which is incorporated herein by reference in its entirety.

### TECHNICAL FIELD

The technology and implementations disclosed in this patent document generally relate to a battery module.

### BACKGROUND

Secondary batteries refer to batteries capable of repeating charging and discharging because mutual conversion between chemical energy and electrical energy is reversible.

Such secondary batteries may be used as energy sources for electric vehicles, hybrid vehicles, energy storage systems (ESSs), etc., which have recently come to prominence, as well as mobile devices.

Secondary batteries may be used in a form in which one or more battery cells manufactured as flexible pouch-type battery cells or rigid prismatic or cylindrical can-type battery cells are electrically connected to each other. In particular, in the case of electric vehicles requiring high power characteristics, a battery module in which one or more cell stacks in which a plurality of battery cells are stacked are electrically connected to each other or a battery pack in which one or more battery modules are electrically connected to each other may be used.

Meanwhile, a battery module may include a sensing assembly sensing a state of a plurality of battery cells. The sensing assembly is configured to sense a state of a plurality of battery cells and transmit the sensed state to the outside (e.g., a battery management unit). To this end, the sensing assembly needs to be connected to a connector communicating with the outside, while being electrically connected to the plurality of battery cells. However, as the number of battery modules increases, a connection structure and communications structure are complicated.

### SUMMARY

The disclosed technology may be implemented in some embodiments to provide a battery module having a robust yet simple coupling structure between parts.

In some embodiments of the disclosed technology, a battery module includes: first and second sub-battery modules respectively including a cell stack including a plurality of battery cells and a sensing assembly sensing a state of the plurality of battery cells and an upper cover covering upper portions of the first and second sub-battery modules, wherein the upper cover includes a plurality of through-holes exposing portions of the first and second sub-battery modules, respectively.

### BRIEF DESCRIPTION OF DRAWINGS

Certain aspects, features, and advantages of the disclosed technology are illustrated by the following detailed description with reference to the accompanying drawings.

FIG. 1 is a perspective view of a battery module according to an embodiment of the disclosed technology.

FIG. 2 is an exploded perspective view of a battery module according to an embodiment of the disclosed technology.

FIG. 3 is a perspective view of a sub-battery module according to an embodiment of the disclosed technology.

FIG. 4 is a perspective view of a sensing assembly according to an embodiment of the disclosed technology.

FIG. 5 is an enlarged view of region A of FIG. 4.

FIG. 6 is an enlarged view of a busbar assembly according to an embodiment of the disclosed technology.

FIG. 7A is an enlarged view of region B of FIG. 6, and FIG. 7B is a cross-sectional view taken alone line I-I′ of FIG. 7A.

### DETAILED DESCRIPTION

Prior to the description of the disclosed technology, terms and words used in the present specification and claims to be described below should not be construed as limited to ordinary or dictionary terms, and should be construed in accordance with the technical idea of the disclosed technology based on the principle that the inventors may properly define their own inventions in terms of terms in order to best explain the invention. Therefore, the embodiments described in the present specification and the configurations illustrated in the drawings are merely the most preferred embodiments of the disclosed technology and are not intended to represent all of the technical ideas of the disclosed technology, and thus should be understood that various equivalents and modifications may be substituted at the time of the present application.

The same reference numerals or symbols respectively illustrated in the attached drawings denote parts or elements that perform the actually same functions. For convenience of description and understanding, the parts or elements will be described by using the same reference numerals or symbols even in different embodiments. In other words, although elements having the same reference numerals are all illustrated in a plurality of drawings, the plurality of drawings do not mean an embodiment.

As used herein, the singular forms are intended to include the plural forms as well, unless the context clearly indicates otherwise. It will be further understood that the terms “comprises,” “comprising,” etc. When used in this specification, specify the presence of stated features, integers, steps, operations, elements, and/or components, but do not preclude the presence or addition of one or more other features, integers, steps, operations, elements, components, and/or groups thereof.

In addition, in the present specification, the expressions, such as an upper side, an upper portion, a lower side, a lower portion, a side, a front surface, a rear surface, and the like, are described based on the drawings and may be expressed differently when the direction of the corresponding object is changed.

It will be understood that, although the terms first, second, etc. May be used herein to describe various elements, these elements should not be limited by these terms. These terms are only used to distinguish one element from another. For example, a first element could be termed a second element, and, similarly, a second element could be termed a first element, without departing from the scope of the disclosed technology.

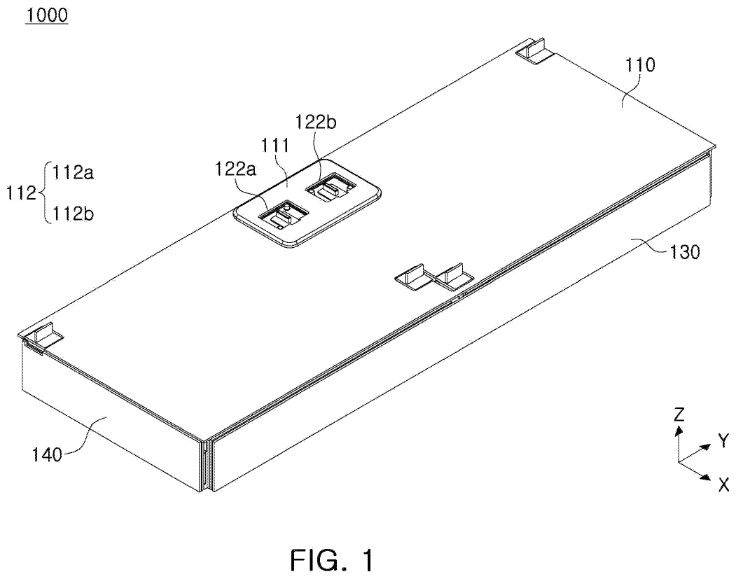

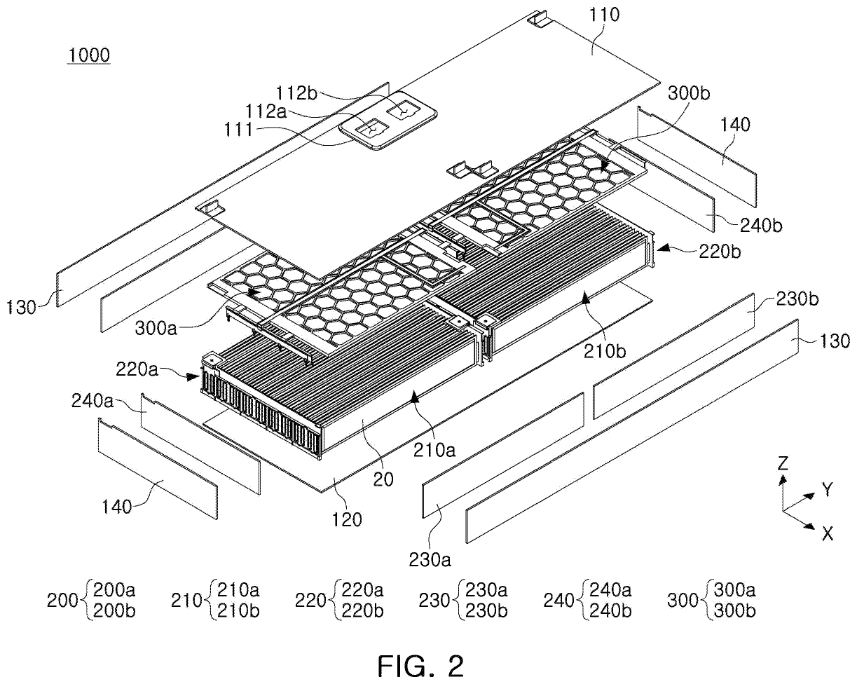

FIG. 1 is a perspective view of a battery module according to an embodiment of the disclosed technology, and FIG. 2 is an exploded perspective view of the battery module according to an embodiment of the disclosed technology.

According to an embodiment of the disclosed technology, a battery module 1000 may include two sub-battery modules 200 (200a, 200b). For example, the battery module 1000 may include a first sub-battery module 200a and a second sub-battery module 200b.

Meanwhile, although not separately shown in the drawings, a center wall may be disposed between the first sub-battery module 200a and the second sub-battery module 200b. That is, in FIG. 2, the first sub-battery module 200a, the central wall, and the second sub-battery module 200b may be sequentially arranged in a Y-direction.

Hereinafter, the sub-battery module 200 may be used as a generic term of the first sub-battery module 200a and the second sub-battery module 200b.

According to an embodiment of the disclosed technology, the sub-battery module 200(200a, 200b) may include a cell stack 210(210a, 210b), a busbar assembly 220(220a, 220b), an insulating pad 230(230a, 230b), and an insulating cover 240(240a, 240b). In addition, the sub-battery module 200 may include a sensing assembly 300 (300a, 300b) disposed above the cell stack 210.

The cell stack 210 may include a plurality of battery cells 20 stacked in one direction. Referring to FIG. 2, the cell stack 210 may include a plurality of battery cells 20 stacked in an X-direction (or a first direction). Within the cell stack 210, the plurality of battery cells 20 may be electrically connected to each other.

The busbar assembly 220 may be electrically connected to the plurality of battery cells 20. In other words, the plurality of battery cells 20 may be electrically connected to each other through the busbar assembly 220.

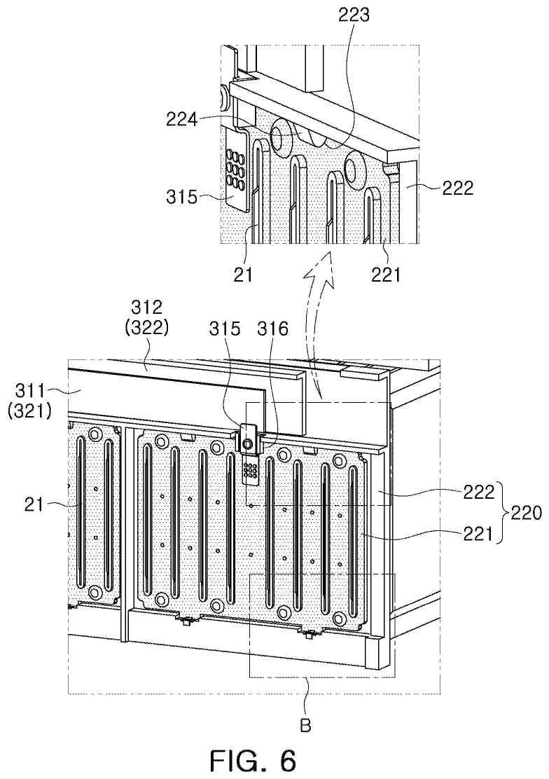

FIG. 6 is an enlarged view of a busbar assembly according to an embodiment of the disclosed technology.

Referring to FIG. 6, the busbar assembly 220 may include a busbar 221 electrically connecting the plurality of battery cells 20 and a busbar frame 222 in which the busbars 221 are disposed. The busbar 221 may be formed of a conductive material, and the busbar frame 222 may be formed of an insulating material.

The busbar 221 may electrically connect two or more adjacent battery cells 20. For example, the battery cells 20 may include an electrode lead 21 drawn out in a length direction of the battery cells 20. Referring to FIG. 2, the battery cells 20 have a length in the Y-direction, and the length direction of the battery cells 20 may refer to the Y-direction. A portion of the electrode lead 21 drawn out in the longitudinal direction of the plurality of battery cells 20 may be inserted into the busbar 221. Accordingly, the plurality of battery cells 20 may be electrically connected to the busbar 221.

According to an embodiment of the disclosed technology, the busbar assembly 220 may have an easy fastening structure. Details thereof are described below.

Each of the four sides of the cell stack 210 may be covered by the insulating pad 230 and an insulating cover 240. Referring to FIG. 2, the insulating pad 230 may cover the side of the cell stack 210 in a stacking direction of the plurality of battery cells 20, that is, in the X-direction. In addition, the insulating cover 240 may cover the side of the cell stack 210 in the longitudinal direction of the plurality of battery cells 20, that is, in the Y-direction.

The insulating pad 230 and the insulating cover 240 may be formed of an insulating material and may be disposed to cover the cell stack 210 in the X and Y-directions, respectively, to electrically insulate the cell stack 210 and cover members to be described below, specifically, a side cover 130 and an end cover 140 formed of aluminum, from each other.

Although not specifically shown in the drawings, the insulating pad 230 may also be disposed between the cell stacks 210. The insulating pad 230 may be alternately stacked with the plurality of battery cells 20. For example, a pair of insulating pads 230 may be disposed for every four battery cells 20. A pair of insulating pads 230 may be disposed along with an insulating member (not shown) for every four battery cells 20, and the insulating pads 230 may be disposed on both sides of the insulating member.

The insulating pad 230 may be attached to both sides of the insulating member and disposed between the plurality of battery cells 20, thereby preventing the plurality of battery cells 20 from swelling.

Meanwhile, according to an embodiment of the disclosed technology, the battery module 100 may include cover members covering the first sub-battery module 200a and the second sub-battery module 200b. The cover members disposed on the outermost side of the battery module 1000 may be formed of a metal material, for example, aluminum.

The battery module 100 may include an upper cover 110 covering upper portions of the first sub-battery module 200a and the second sub-battery module 200b, a lower cover 120 covering lower portions of the first sub-battery module 200a and the second sub-battery module 200b, and side covers 130 and end covers 140 covering the sides of the first sub-battery module 200a and the second sub-battery module 200b in different directions.

The upper cover 110 and the lower cover 120 may cover the first sub-battery module 200a and the second sub-battery module 200b at once from thereabove and therebelow.

The upper cover 110 may include a seating portion 111. A certain component may be disposed on the seating portion 111 as needed. For example, a member coupled to a cell monitoring unit (CMU) 340(340a, 340b) of the first and second sub-battery modules 200a and 200b, which will be described below, may be disposed on the seating portion 111.

The seating portion 111 may be formed at a boundary between the first sub-battery module 200a and the second sub-battery module 200b, that is, in the center of the battery module 1000 in a longitudinal direction, and may overlap portions of the first sub-battery module 200a and the second sub-battery module 200b in a Z-direction.

The seating portion 111 may include a plurality of through-holes 112a and 112b. The plurality of through-holes 112a and 112b may be spaced apart from each other in the Y-direction, which is an arrangement direction of the sub-battery module 200, on the upper cover 110, and each of the plurality of through-holes 112a and 112b may expose portions of the first sub-battery module 200a and the second sub-battery module 200b.

In detail, a portion of a sensing assembly (hereinafter, referred to as a first sensing assembly 300a) of the first sub-battery module 200a and a portion of a sensing assembly (hereinafter, referred to as a second sensing assembly 300b) of the second sub-battery module 200b to be described below may be exposed through the plurality of through-holes 112a and 112b.

Meanwhile, the seating portion 111 may protrude from the upper cover 110 to be distinguished from other portions of the upper cover 110 as shown in the drawing, but may not protrude from the upper cover 110 and may be on the same level as those of other portions of the upper cover 110. That is, in another embodiment, the seating portion 111 may have a flat shape.

The side cover 130 may cover the sides of the first sub-battery module 200a and the second sub-battery module 200b in the X-direction. Since the insulating pads 230 are disposed on the outside of the first sub-battery module 200a and the second sub-battery module 200b in the X-direction, the side cover 130 may be disposed to cover the insulating pads 230. The side cover 130 may cover the first sub-battery module 200a and the second sub-battery module 200b in the X-direction at the same time.

The end covers 140 may cover the sides of the first sub-battery module 200a and the second sub-battery module 200b in the Y-direction. Since the insulating covers 240 are disposed on the outside of the first sub-battery module 200a and the second sub-battery module 200b in the Y-direction, the end covers 140 may be disposed to cover the insulating covers 240. The end covers 140 may cover the first sub-battery module 200a on one side in the Y-direction and cover the second sub-battery module 200b on the other side in the Y-direction.

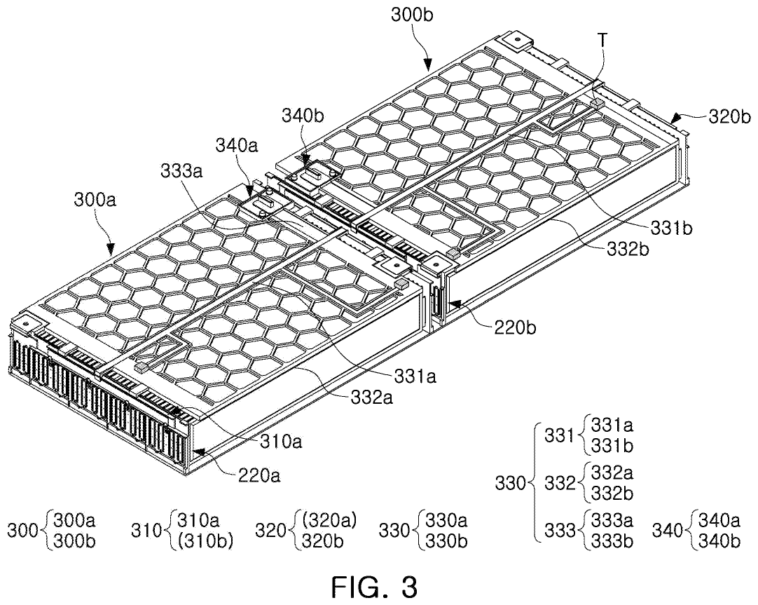

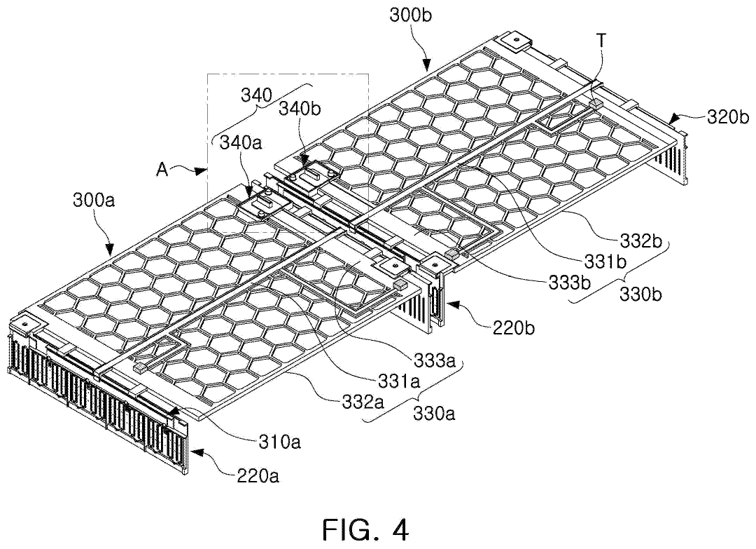

FIG. 3 is a perspective view of a sub-battery module according to an embodiment of the disclosed technology, and FIG. 4 is a perspective view of a sensing assembly according to an embodiment of the disclosed technology. In FIG. 3, the side plate 230 and the end plate 240 are omitted.

According to an embodiment of the disclosed technology, the sensing assembly 300 (300a, 300b) may be coupled to the upper portion of the cell stack 210 of the sub-battery module 200. In this specification, the sensing assembly 300 may be a generic term of the first sensing assembly 300a and the second sensing assembly 300b. In addition, although the present specification describes the sensing assembly 300 separately from the sub-battery module 200 for convenience of description, the sub-battery module 200 may include the sensing assembly 300.

The sensing assembly 300 may be a component sensing information, such as voltage, temperature, and the like of the plurality of battery cells 20 constituting the sub-battery module 200.

The sensing assembly 300 may include a first sensing portion 310(310a, 310b), a second sensing portion 320(320a, 320b), and a bridge portion 330(330a, 330b) connecting the first sensing portion 310 to the second sensing portion 320. The second sensing portion 310b of the first sensing assembly 300a and the first sensing portion 320a of the second sensing assembly 300b are not shown in the FIGs. Nevertheless, it is obvious that they face each other in the y-axis direction at the boundary between the first sub battery module 200a and the second sub battery module 200b.

Referring to FIGS. 3 and 4, the first sensing portion 310 and the second sensing portion 320 may be coupled to the busbar assemblies 220 of the sub-battery module 200, respectively. That is, the first sensing portion 310 and the second sensing portion 320 may be spaced apart from each other in the longitudinal direction of the plurality of battery cells 20, and the bridge portion 330 may connect the first sensing portion 310 to the second sensing portion 320. Accordingly, the bridge portion 330 may extend in the longitudinal direction of the plurality of battery cells 20.

The first sensing portion 310 and the second sensing portion 320 may include first substrates 311 and 321 and first bases 312 and 322 on which the first substrates 311 and 321 are disposed.

The first substrates 311 and 321 may be printed circuit boards (PCBs) or flexible printed circuit boards (FPCBs), and the first bases 312 and 322 may be formed of an insulating material. The first bases 312 and 322 may serve to support the first substrates 311 and 321.

The first substrates 311 and 321 and the first bases 312 and 322 may extend in the stacking direction of the plurality of battery cells 20.

The first substrates 311 and 321 may be electrically connected to the busbar assembly 220. The first substrates 311 and 321 may be electrically connected to the busbar assembly 220 to receive voltage information of the plurality of battery cells 20. The first substrate 311 of the first sensing portion 310 and the first substrate 321 of the second sensing portion 320 may receive voltage information of the plurality of battery cells 20 different from each other.

The bridge portion 330 may include a second substrate 331 and preferably may include a second base 332 on which the second substrate 331 is disposed. In the sensing assembly 300 according to an embodiment of the disclosed technology, since the cell monitoring unit (CMU) 340 is disposed above the cell stack 210, the second base 332 may preferably be included to support the cell monitoring unit (CMU) 340.

The bridge portion 330 may generally extend in the longitudinal direction of the sub-battery module 200 and may be disposed to cover an upper portion of the cell stack 210.

The second substrate 331 may be an FPCB. The second substrate 331 may be bent in the Z-direction at both ends in the longitudinal direction to be connected to the first substrate 311 of the first sensing portion 310 and the first substrate 321 of the second sensing portion 320. The second base 332 may be formed of an insulating material and may serve to support the second substrate 331.

The second substrate 331 may be connected to one or more temperature sensors T, and accordingly, the second substrate 331 may receive temperature information of the plurality of battery cells 20. Also, since the second substrate 331 is connected to the first substrates 311 and 321, the voltage information of the plurality of battery cells 20 collected from the first substrates 311 and 321 may be transferred to the cell monitoring unit (CMU) 340 to be described below together with the temperature information of the plurality of battery cells 20.

According to an embodiment of the disclosed technology, the sensing assembly 300 may include the cell monitoring unit (CMU) 340 (340a, 340b). The cell monitoring unit (CMU) 340 may include a first cell monitoring unit (CMU) 340a provided in the first sensing assembly 300a and a second cell monitoring unit (CMU) 340b provided in the second sensing assembly 300b.

The cell monitoring unit (CMU) 340 may be formed at a boundary between the first sub-battery module 200a and the second sub-battery module 200b. Referring to FIG. 4, the first cell monitoring unit (CMU) 340a may be formed to be adjacent to the second sub-battery module 200b, and the second cell monitoring unit (CMU) 340b may be formed to be adjacent to the first sub-battery module 200a. According to an embodiment of the disclosed technology, the first cell monitoring unit (CMU) 340a and the second cell monitoring unit (CMU) 340b are disposed to be adjacent to each other, and thus, the first and second cell monitoring units (CMUs) 340a and 340b may be connected to a single instrument, and the instrument may receive sensing information of both the first and second sub-battery modules 200a and 200b.

The first cell monitoring unit (CMU) 340a and the second cell monitoring unit (CMU) 340b may face each other in the arrangement direction of the first sub-battery module 200a and the second sub-battery module 200b. The first cell monitoring unit (CMU) 340a and the second cell monitoring unit (CMU) 340b may be symmetrical to each other with respect to the stacking direction of the plurality of battery cells 20. Furthermore, the first sensing assembly 300a and the second sensing assembly 300b may also be symmetrical to each other with respect to the stacking direction of the plurality of battery cells 20.

Also, as described above, the cell monitoring unit (CMU) 340 may be provided in the Z-direction. For example, the cell monitoring unit (CMU) 340 may be provided on one surface of the second base 332. The cell monitoring unit (CMU) 340 may be provided on one surface of the second base 332 and connected to the second substrate 331. In addition, the cell monitoring unit (CMU) 340 may be provided on one surface of the second base 332 and exposed through the through-holes 112a and 112b of the upper cover 110.

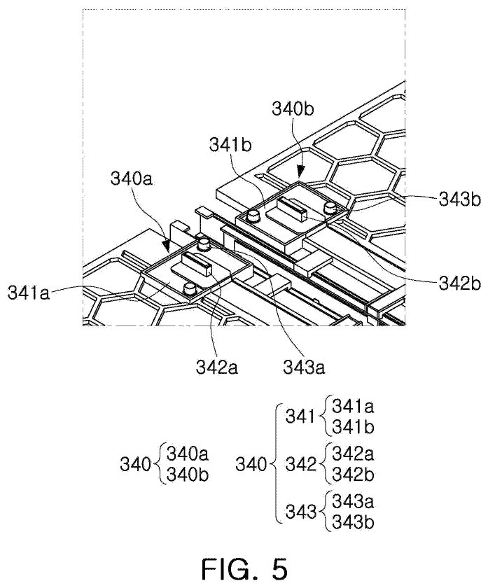

FIG. 5 is an enlarged view of region A of FIG. 4. A structure of the cell monitoring unit (CMU) 340 according to an embodiment of the disclosed technology may be more clearly identified through FIG. 5.

According to an embodiment of the disclosed technology, the cell monitoring unit (CMU) 340(340a, 340b) may include a main board 341(341a, 341b) and a connector 342(342a, 342b).

A portion of the second substrate 331 may be disposed on the main board 341. For example, the second substrate 331 may extend onto the main board 341 of the cell monitoring unit (CMU) 340 on the second base 332 and may be fixed to the main board 341. Hereinafter, a portion extending from the second substrate 331 to the main board 341 of the cell monitoring unit (CMU) 340 is defined as a third substrate 333. Accordingly, voltage and temperature information on the plurality of battery cells 20 constituting the sub-battery module 200 may be collected by the main board 341.

The connector 342 may be provided on the main board 341. For example, the first cell monitoring unit (CMU) 340a may include a first connector 342a, and the second cell monitoring unit (CMU) 340b may include a second connector 342b. The connector 342 provided on the main board 341 may be a low voltage connector.

The connector 342 may protrude in the Z-direction in which the upper cover 110 is disposed and coupled. The connector 342 may be exposed through the through-hole 112(112a, 112b) formed in the upper cover 110.

For example, the connector 342 may be coupled to another member to serve to transfer information on the plurality of battery cells 20 collected in the main board 341 to the outside.

Next, a fastening structure of the busbar assembly 220 according to an embodiment of the disclosed technology will be described with reference to FIGS. 6 to 9.

The busbar assembly 220 may be disposed at both ends of the sub-battery module 200 in the longitudinal direction. The busbar assembly 220 may include the busbar 221 and the busbar frame 222. The busbar 221 may be seated on the busbar frame 222, which may be disposed at both ends of the sub-battery module 200 in the longitudinal direction.

According to an embodiment of the disclosed technology, the busbar assembly 220 may have a structure capable of simple and robust coupling between the busbar 221 and the busbar frame 222.

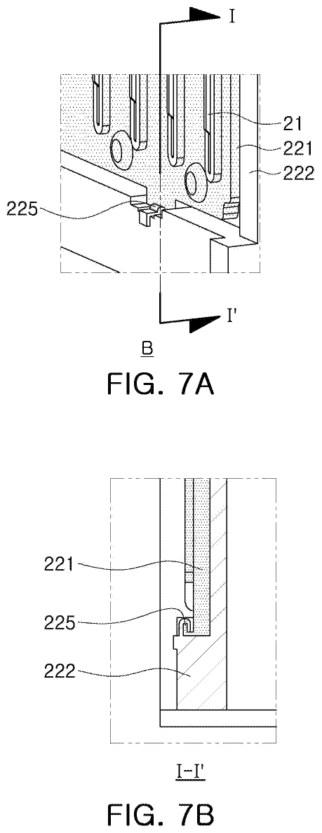

Referring to FIGS. 7A and 7B, the busbar 221 may be fixed to the busbar frame 222 through hook coupling. For example, the busbar 221 may include a hook ring 225 at a lower end thereof, and the busbar frame 222 may include a recess to which the hook ring 225 is hooked. When the busbar 221 is seated on the busbar frame 222, the hook ring 225 may be caught in the recess of the busbar frame 222, so the busbar 221 may be fixed to the busbar frame 222. According to an embodiment of the disclosed technology, the busbar 221 may be fixed to the busbar frame 222 in a simpler manner.

Referring to FIG. 6, the busbar 221 may include a recess 223 at an upper end thereof. The recess 223 may be configured not to overlap a support protrusion 224 of the busbar frame 222. The busbar frame 222 may include the support protrusion 224 protruding to a region in which the busbar 221 is seated at the upper end thereof, and the busbar 221 may have the recess 223 in a position corresponding to the support protrusion 224. For example, the busbar 221 may be hook-coupled to the busbar frame 222 in a state in which the recess 223 and the support protrusion 224 face each other. In a state in which the busbar 221 is coupled to the busbar frame 222, there may be little gap between the recess 223 and the support protrusion 224.

Meanwhile, the busbar assembly 220 may be connected to the sensing assembly 300 in addition to the plurality of battery cells 20 constituting the cell stack 210. The sensing assembly 300 may be connected to the busbar 221 to sense voltage information of the plurality of battery cells 20. Specifically, the first sensing portion 310 and the second sensing portion 320 of the sensing assembly 300 may be connected to the busbars 221 at both ends of the plurality of battery cells 20 in the longitudinal direction, respectively.

Referring to FIG. 6, the sensing assembly 300 may be connected to the busbar 221 through the sensing terminal 315. For example, in a state in which the sensing terminal 315 is fixed to a heat-sealed portion 316, one end of the sensing terminal 315 may be connected to the busbar 221 and the other end thereof may be connected to the first substrate 311 of the first sensing portion 310. The heat-sealed portion 316 may be provided in the busbar frame 222, and in a state in which the sensing terminal 315 is inserted into the heat-sealed portion 316, one end and the other end of the sensing terminal 316 may be fixed to the busbar 221 and the first substrate 311, respectively, through welding or soldering.

Meanwhile, although the first sensing portion 310 is illustrated as a reference in the accompanying drawings, the above coupling structure may be equally applied to the second sensing portion 320.

As described above, the battery module 1000 according to an embodiment of the disclosed technology has the advantage of enabling simple and robust coupling between parts.

Only specific examples of implementations of certain embodiments are described. Variations, improvements and enhancements of the disclosed embodiments and other embodiments may be made based on the disclosure of this patent document.

What is claimed is:

1. A battery module comprising:
first and second sub-battery modules respectively including a cell stack including a plurality of battery cells and a sensing assembly sensing a state of the plurality of battery cells; and
an upper cover covering upper portions of the first and second sub-battery modules,
wherein the upper cover includes a plurality of through-holes exposing portions of the first and second sub-battery modules, respectively.

2. The battery module of claim 1, wherein
the plurality of battery cells are stacked in a first direction, the first and second sub-battery modules are arranged in a second direction crossing the first direction, and
the plurality of through-holes are spaced apart from each other in the second direction on the upper cover.

3. The battery module of claim 1, wherein
the sensing assembly includes:
a first sensing portion disposed on one side of the cell stack in a longitudinal direction;
a second sensing portion disposed on the other side of the cell stack in the longitudinal direction; and
a bridge portion connecting the first sensing portion to the second sensing portion,
wherein the bridge portion is disposed above the cell stack.

4. The battery module of claim 3, further comprising the sensing assembly further includes a cell monitoring unit extending from the bridge portion and exposed through the plurality of through-holes.

5. The battery module of claim 4, wherein
the bridge portion includes:
a second base disposed to cover an upper portion of the cell stack;
a second substrate disposed on the second base and connecting the first sensing portion to the second sensing portion; and
a third substrate extending from the second substrate and connected to the cell monitoring unit.

6. The battery module of claim 4, wherein the cell monitoring unit is disposed to be adjacent to a boundary between first and second sub-battery modules.

7. The battery module of claim 4, wherein the sensing assemblies of the first and second sub-battery modules are disposed to be symmetrical to each other with respect to a stacking direction of the plurality of battery cells.

8. The battery module of claim 4, wherein the cell monitoring unit includes a connector protruding toward the upper cover, and the connector is exposed through the plurality of through-holes.

9. The battery module of claim 3, wherein the first sensing portion and the second sensing portion each sense voltage information of the plurality of battery cells.

10. The battery module of claim 1, wherein
the first and second sub-battery modules include a busbar assembly including:
a busbar electrically connected to the plurality of battery cells; and
a busbar frame on which the busbar is seated,
wherein the busbar is fixed to the busbar frame through hook coupling.

11. The battery module of claim 10, wherein the busbar frame includes a support protrusion protruding to a region in which the busbar is seated, and the busbar includes a recess supported to the support protrusion.
